(19) United States
(12) Patent Application Publication
(10) Pub. No.: US 2008/0155394 A1
(43) Pub. Date: Jun. 26, 2008

(54) VARIABLE DATA PRINTING

(75) Inventors: Royston SELLMAN, Sheffield (GB); Fabio GIANNETTI, Boise, ID (US); Alexis CABEDA, Porto Alegre (BR); Guilherme BEDIN, Porto Alegre (BR); Fabio MOREIRA, Porto Alegre (BR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L. P., Houston, TX (US)

(21) Appl. No.: 11/932,659

(22) Filed: Oct. 31, 2007

(30) Foreign Application Priority Data
Oct. 31, 2006 (GB) 0621633.7

(51) Int. Cl. G06F 17/00

(52) U.S. Cl. 715/235

(57) ABSTRACT

A method of printing a document is disclosed: A format template file is generated by defining locations and sizes on a page of at least two copy holes into which a content element is to be inserted. A group object is created which incorporates the two copy holes by generating a hierarchical data structure which specifies an identifier for the group object and identifies each copy hole of which the group object is comprised. The group object is replicated on a page of the format template file. A merged file is created by merging the format template file, a style template file specifying a font for a text content element. Each content element is identified in respect of a copy hole. The merged file is rendered to create a bitmap. A print engine is operated in accordance with the bitmap to print a document.

### RELATED APPLICATIONS

The present application is based on and corresponds to British Application Number 0621633.7 filed Oct. 31, 2006, the disclosure of which is hereby incorporated by reference herein in its entirety.

### BACKGROUND TO THE INVENTION

1. Field of the Invention

In the domains of advertising and marketing an increasingly high premium is placed on the ability to personalise publicity material. Accordingly, flyers, catalogues or other ‘direct marketing material’ are perceived to have greater value where their semantic content is tailored precisely, for example, to a particular demographic group, a particular time of year or both. The ability to print commercial material whose content is more highly relevant to a smaller group of people, or relevant for a shorter period of time necessarily means an overall increase in the amount of authoring which takes place, leading in turn to a need to create documents more quickly. The present invention relates to the manipulation of data in which content is recorded in order to enable fast, easy and precise creation of digitally-recorded documents used for printing that content.

2. Description of Related Art

Traditionally, the creation of a commercial document for printing typically follows a well-established path. The content of the document will usually already have been determined in advance by the content owner, often a merchant of some description seeking to market products or services. A graphic designer will be required to design the document, which will usually involve positioning and sizing of various content elements—such as photographs, other drawings and blocks of text which have been retrieved from data storage—onto a page. In addition to the position and size of content elements, the designer will also specify a ‘style’ for them. That is to say the typographical arrangement of text and parameters such as the typeface, font colour and font sizes. Traditionally, each of these formatting activities must be performed each time a new document is designed.

This process of designing a document on a computer will result in a data file which records instructions on how the final printed document should appear. This data file contains: the content elements, such as images, text and so on; instructions regarding their format i.e. how to position them and how big they are; and their style. These printing instructions, however, are not assimilable by a print engine, which operates simply on the basis of a bitmap input for a particular page. The next stage of the printing process is, therefore, the transformation of the instructions created out of merging the content, formatting and style into bitmap data which is assimilable as a series of instructions by a print engine. This data will instruct the print engine where, to what extent and what colour or colours, to deposit ink or toner on a page. This process is known in the art as ‘rendering’ or ‘raster image processing’ (RIPing for short). Rendering can be a processing-intensive operation which is increasingly demanding the higher the quality of the final print—since the greater the required resolution of the bitmap the larger the quantities of data which have to be generated by the rendering process.

Traditionally, when a new document containing different content is to be published, the entire process must be repeated. More recently, however, it has become possible to perform the various parts of the process in ways that enable some of the process to be re-used. For example, it is now possible to create an abstract ‘format template’ file. This kind of file specifies a ‘copy hole’, i.e. the location on a page at which a content element is to inserted, as well as the size of the area on the page reserved for that content element, but does not include the content elements themselves. Instead, for each copy hole, the template simply includes a pointer to the data file where the appropriate content element to be inserted is stored. In addition, the style or styles to be applied to each content element identified in the format template file are specified in a separate ‘style template’ data file. At print time the content elements are retrieved, merged with the format template to place them in the appropriate locations and the style template used to apply the appropriate style to each item. The resultant, complete instructions are then rendered in the normal manner.

The separation of style and format enables different styles to be applied to identically formatted content, for example, depending upon the target group of the resultant document. Further, by specifying document format in template form as a series of copy holes where content elements are to be inserted, it is possible, simply by changing the format template to point to a different data files, to change the content elements in a document without having reformat on each occasion.

### SUMMARY OF THE INVENTION

The invention is set out in the claims.

### BRIEF DESCRIPTION OF DRAWINGS

Embodiments of the invention, will now be described, by way of example, and with reference to the accompanying drawings, in which:

FIG. 1 is a schematic illustration of users and resources in the exemplified scenario of an embodiment of the present invention;

FIG. 2 is an illustration of content elements provided to a designer;

FIG. 3 is an illustration of how a graphic designer envisages the content elements of FIG. 2 appearing on a printed page;

FIG. 4 is an illustration of a template for the page of FIG. 2, constructed by a graphic designer on a Graphical User Interface;

FIG. 5 is an illustration of the template of FIG. 3 expressed and recorded in XML syntax;

FIGS. 6A-C illustrate the creation of group objects in accordance with an embodiment of the present invention;

FIG. 7 is an graphic illustration of the hierarchical structure of a group object in FIG. 6;

FIG. 8 is an illustration of a template including a group object expressed and recorded in XML syntax; and

FIG. 9 is an illustration of the replication of a group object rapidly to replicate the format data captured in FIGS. 4 and 5.

### DESCRIPTION OF PREFERRED EMBODIMENTS

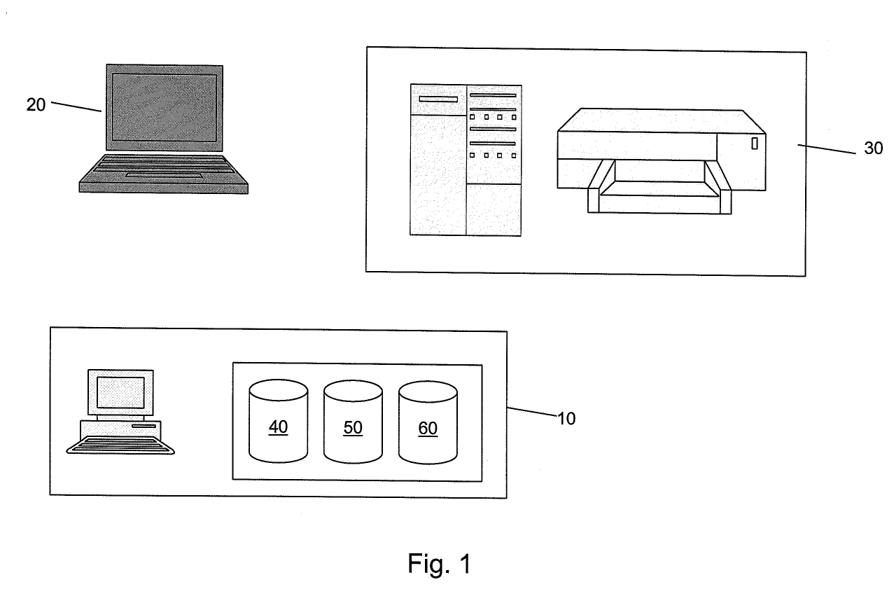

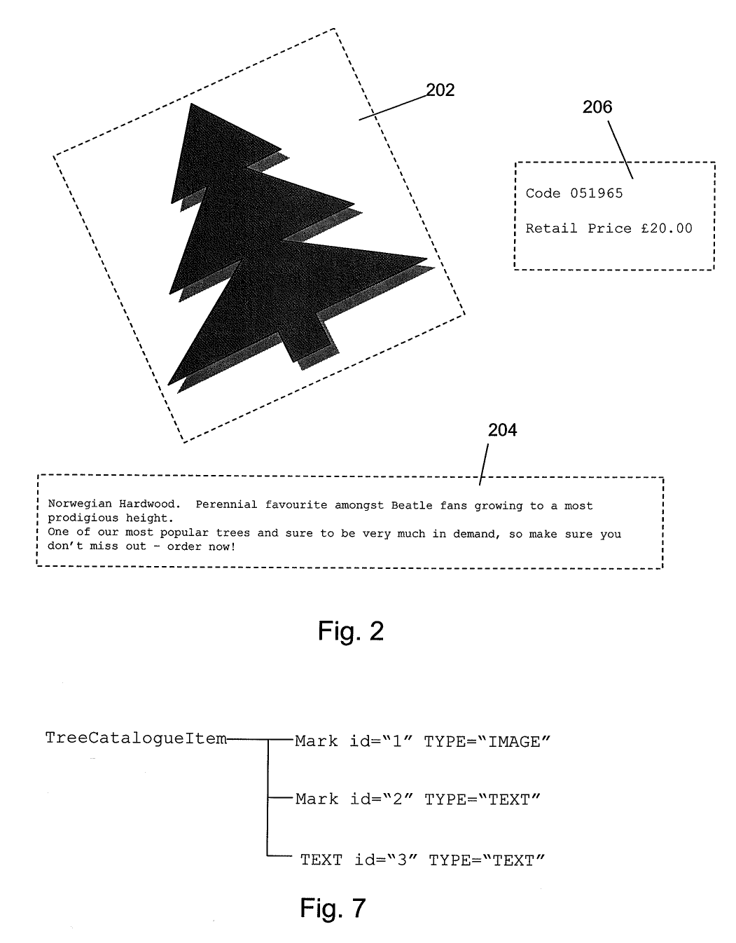

In order best and most clearly to illustrate embodiments of the present invention a simple process of creating a page of a catalogue will be exemplified. Referring now to FIGS. 1 and 2, the scenario involves a merchant organisation 10, which in this example will be a distributor of plants and trees. The merchant 10 wishes to produce a catalogue of the various plants and trees which it offers. To this end it engages a graphic designer, 20. The merchant will send, to the graphic designer, samples of the various content elements which it wishes to have included in the catalogue; the graphic designer's job is to arrange those in a manner which is both clear and aesthetically pleasing to a would-be purchaser. The graphic designer will provide the designed layout to the merchant in order that the merchant can then send the design to the merchant's print shop 30 for printing. In an alternative but entirely equivalent scenario, the print shop will be an external organisation.

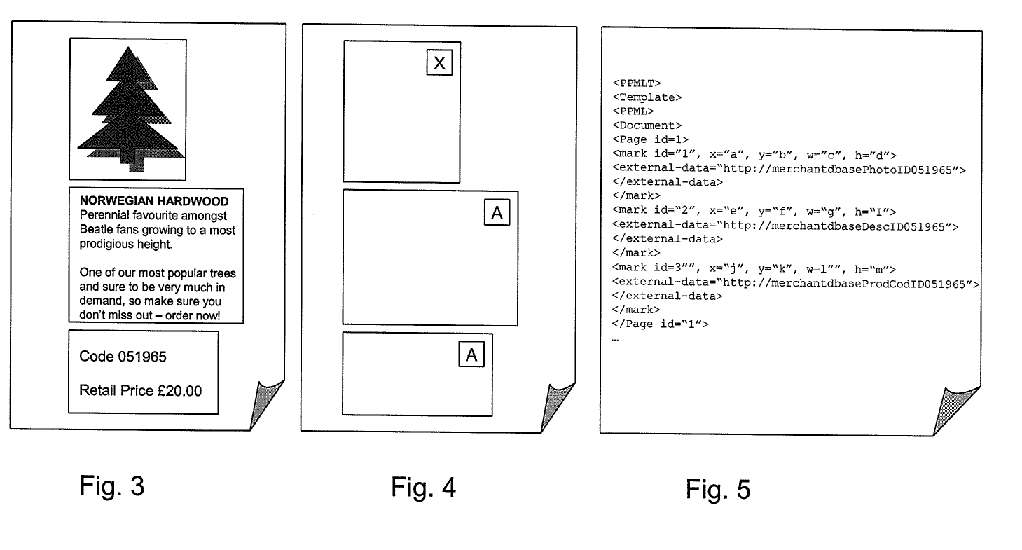

Referring now to FIG. 2, in the present example, the merchant retrieves, from three different databases 40, 50, 60 under the merchant's control, three data files three data files containing three content items: a photograph of a tree 202, a textual description 204 and a price and code 206. These are then sent to the designer. The layout which the designer desires to use for the three content items is composed on the designer's computer 302 using a graphical authoring tool. Typically, the data files sent to the designer will contain low-resolution versions of the content elements to reduce file sizes, and the designer will use these to ‘mock-up’ the page in the way that he believes will be appropriate. The designer's intended layout being shown in FIG. 3. Having determined the relative sizes and positions of the content elements in this way, the designer then authors a format template which will be used to produce such a layout in the finished document. This, the graphic designer achieves, using well-known graphical authoring techniques, by specifying, on a virtual page, a copy hole where each content element is to be inserted, as illustrated in FIG. 4. Each copy hole where an element is identified by a location on the page and a size, as well as being labelled as to its content type (the picture, being provided in the form of a .jpg file is labelled with an “X”, while each of the text content items are labelled with an “A”). In addition, the content element which is intended to be inserted into the copy hole in the finished document is specified by use of a Uniform Resource Indicator. Each URI points to the location of a specified data file within one of a number of databases under the control of the merchant. The format data displayed via the user interface is saved as a format template file, recorded in Personalised Print Markup Language Template (PPMLT), which records the format recorded by the author via the GUI as a series of instructions in markup language of the general kind shown in FIG. 5. In addition to the copy holes for content elements, the designer also specifies the various style parameters which are required in order to accommodate that template, such as the typographical arrangement of text in an element, the typeface, colour and font size. Data regarding the style to be applied to the content elements is stored in a separate data file known as the style template which will typically be recorded as an XSL-FO (Extensible Stylesheet Formatting Object). At print time, the PPMLT file is merged with the content elements and the style recorded in the style template file is applied to it and the merged data file is then rendered to a bitmap for use by a print engine.

Referring now to FIG. 5, the precise instructions contained within the PPMLT file which records the instructions entered by the designer via his user interface is shown. The instructions for the placement of the various locations at which the content elements will, at print time, be inserted are expressed as a series of machine-readable ‘tags’, which are, in effect labels the extent of which is defined by angle-brackets. The content of the text between angle brackets is interpreted or ‘parsed’ by a computer program, which is well-known in the art.

Thus, the extent of the entire document to be created is defined as lying between the two ‘Document’ tags—one which denotes the start <Document> and the other then end </Document> of that ‘fragment’ of PPML. Between these two tags lie the precise instructions for formatting a template. It can readily be appreciated from the syntax of PPML that it is given to the creation of a hierarchical structure, and so, within the bounds of the item ‘document’ there are defined objects which are ‘pages’. In this example, there is only a single page, and the contents of that page are defined as lying between the two ‘page’ tags; nonetheless the tags contain the ‘attribute’—interpretable by the parser, of the page identifier:
id=“1”

If a subsequent page is added, the id value of that subsequent page will increment and the pages can be distinguished from one another. A page contains one or more ‘marks’, this being the term used to denote a copy hole within which a content element is to be inserted. As with a page, or indeed anything which may need identification to distinguish from other objects of the same type, each mark has an identifier. In addition, the opening ‘mark’ tag includes, in its attributes, the x,y Cartesian coordinates of the copy hole on the page, as well as its width (w) and height (h); i.e. sufficient information to locate and size a content element when the content element is merged with the template. Thus the mark tags precisely define a copy hole for the insertion of a content element. However, to define the content element itself, i.e. the data which is to be inserted in the copy hole at print time, further information is required and this is provided inside the mark tags, where
<external-data . . . >
   tags have attributes which specify the type (i.e. whether a photograph or text, for example) and location of the content element to be inserted. The location is specified in the attributes by the use of a URI pointing to the relevant merchant database location, interpretable by the parser as an instruction to retrieve the content element at print time.

The creation of a PPML ‘document’, including the assigning of incrementing ordinal values to such attributes as page id is something which is performed automatically by the software within the graphic authoring tool, using data input by the graphic designer via the graphical user interface, as well as identification data which may be entered manually by the designer (i.e. in textual form via a dialogue box, say) such as the URIs for the content elements, and so on. NB, the specifics of the XSL-FO file are not discussed hererin. The reason for this is simply that, because that file contains style data which is to be applied to the various content elements in the template regardless of the instructions within the template itself, the style template data file remains unchanged and therefore is not directly germane to those aspects of variable data printing to which the present invention relates.

This manner of authoring and recording data provides for great flexibility in relation to the construction of pages for printing. Thus, in the event that a distributor wishes to publish a catalogue of some other items of commerce but wishes to preserve the use of his ‘house style’, i.e. using the same format and style, it is possible to re-use much of the authoring work from the previous catalogue, simply using the existing PPML file to create a new file which differs materially from the original only in that it contains different URIs, specifying the new content elements that are to be inserted at the various locations, so that, at print time, the new content elements are retrieved from the relevant databases and merged with the format template file and have the style template applied to them.

Thus far only a very simple scenario has been illustrated, i.e. the authoring of a single page of a catalogue having content elements which, semantically, relate to only a single item. It is often the case that a distributor may wish to re-use certain elements of the house style while altering other aspects of a catalogue's design. Thus, in the present example, say, the distributor may wish to retain the formatting of the picture and the two blocks of text, while wishing to reduce the size and alter the page setup from portrait to landscape, say (for example because this accommodates a larger number of catalogue items per page).

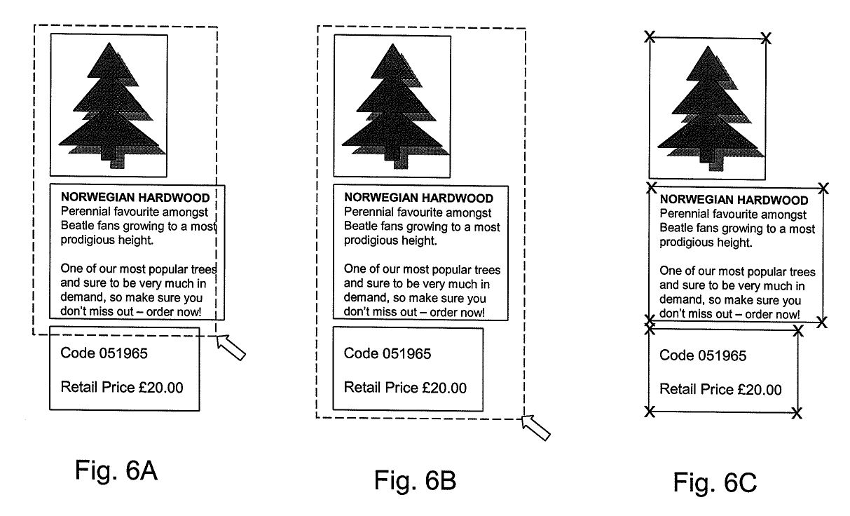

Referring now to FIGS. 6A-C, such modifications are more easily facilitated by the provision of additional editing capability at the designer's authoring tool, namely, the ability of a designer to ‘group’ certain specified copy holes together. This enables a plurality of copy holes (and thus, when pointed to from within the copy holes, in effect, the content elements which are to occupy them in a merged document) to be treated as a single object and thus repeated across, or down a page. In the example shown in FIG. 6, the copy holes shown in FIG. 2 are designated as a group by the designer using the graphical interface on the designer's authoring tool. This is achieved by the formation, using the cursor, of a box around the three items, the process of which is illustrated in FIGS. 6A and B. Once the box has been used to select the three items—so that each item is indicated as selecte as shown in FIG. 6C, a tool on the user interface providing a command short-cut, or the command itself can be employed to designate each of these items as forming part of a group. On designating these elements as a group, the interface will prompt the designer for certain input data a name for the group of elements, here TreeCatalogueItem. This operation thus causes the authoring tool to create a virtual object TreeCatalogueItem which, in reality, is simply the logical root of a hierarchy of the original constituent elements that go to form the newly created group object, the logical structure of which is shown in FIG. 7 Thus, although the three content elements are still stored individually, a single URI to the object TreeCatalogueItem will be sufficient as a pointer from the format template file in order to retrieve and format all the content elements in the group at print time.

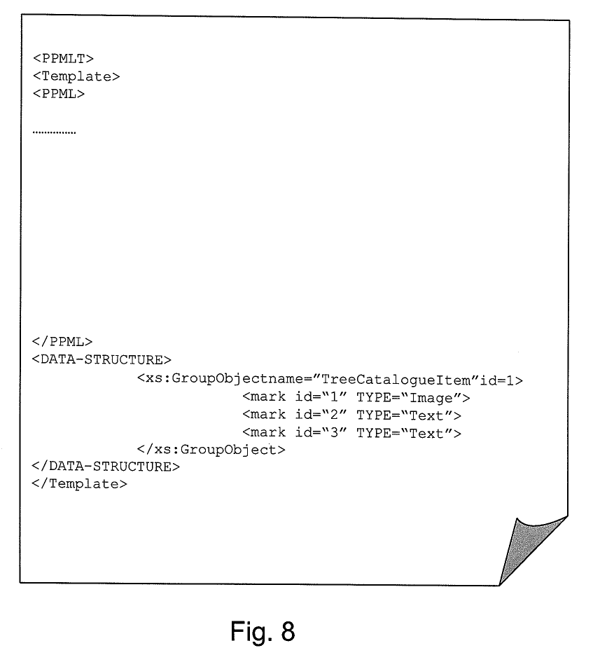

Referring to FIG. 8, this has the effect of creating a modifieId PPMLT file (the section of which that appears in FIG. 5 having been largely omitted for brevity), which now includes an additional section, denoted by a pair of tags defining a

### <DATA-STRUCTURE>

fragment. The data structure fragment includes one or more GroupObjects, each having a name specified by the attribute of the opening
<GroupObject>
   tag. The attribute specifies the XML Schema—i.e. the set of rules according to which the structure content and semantics of the PPML tags are to be interpreted—as being GroupObject and identifies the object as TreeCatalogueItem. Since there may be more of such items, there is, additionally a further identifier Id=“1”, a value which will be automatically incremented for further specified group objects which also are Tree Catalogue Items (i.e. contain a picture of a tree, a description in text and a price and code in text).

The individual copy holes in the group are thus identified by reference to the information contained with the attributes defining them in the Template part of the markup file. Moreover, their relative position on a page is likewise captured during the process of capturing them as a group. Simply described, this is achieved by defining a sub-page whose boundaries are determined by the size of the selection box used by the designer to indicate the size of the group. The locations of the copy holes are then expressed relative to the defined sub-page.

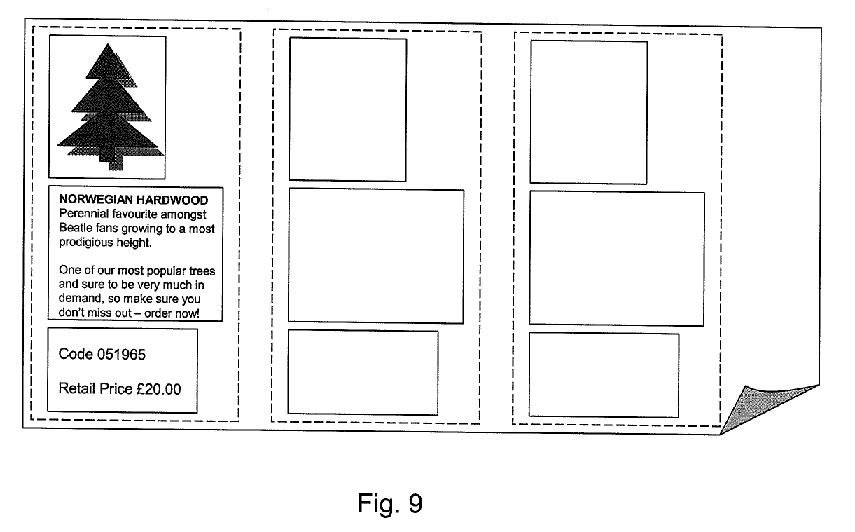

Referring now to FIG. 9, having created a group out of what were previously three separate copy holes, the task of replicating all three copy holes with their formatting—that is to say their sizes and relative positions, no longer requires the individual positioning of the objects. Instead, the object TreeCatalogueItem can now be positioned at a specified location on—in this instance—a landscape page using the graphical interface. The TreeCatalogueItem will incorporate, as is shown explicitly in FIG. 9A, each of the individual objects and their relative sizes and positions. In this manner, it is, therefore, possible to replicate—as shown in FIGS. 9B and 9C, rapidly multiple objects which have already been formatted. This provides the ability rapidly to reproduce the group object while retaining all of the format features which were specified, thus reducing considerably the labour and care required to produce repetitions of groups of objects on a page or across several pages. Further, since the group object is comprised of the copy holes the same grouping can be used for other content items when the copy holes point to those different items.

1. A method of authoring a document for use in printing comprising the steps of:
generating a format template by creating at least two copy holes on a page into which a content element is to be inserted by specifying, for each identified copy hole:
a location on the page for the copy hole,
a size for the copy hole,
an identifier of a location from which a content element may be retrieved for insertion into the copy hole;
creating a group object which incorporates two or more copy holes by:
generating a hierarchical data structure which specifies an identifier for the group object and identifies each copy hole of which the group object is comprised; and
replicating the group object at one or more further locations on the page.

2. The method according to claim 1 further comprising the step of designating, for each copy hole, a content item to be inserted by specifying a resource locator for the content item in respect of the copy hole.

3. The method according to claim 2 further comprising the step of authoring a style template specifying at least a text font for a text content element to be inserted in a copy hole.

4. The method according to claim 3 further comprising the step of merging the format template, a content element identified in the format template and the style template to create a complete document.

5. A method of generating a format template file for use in printing comprising the steps of:
defining a page
creating at least two copy holes on the page into which a content element is to be inserted by specifying for each copy hole:
a location on the page for the copy hole
a size of the copy hole;
an identifier of a location from which a content element may be retrieved for insertion into the copy hole; and
creating a group object which incorporates the two copy holes by: generating a hierarchical data structure which specifies an identifier for the group object and identifies each copy hole of which the group object is comprised.

6. The method according to claim 5, wherein creating the group object additionally comprises the step of capturing relative sizes and positions of the copy holes within the group.

7. The method according to claim 6 further comprising the step of replicating the group object a plurality of times on the page, thereby to replicate each of the copy holes in the group object and the relative size and spacing of the copy holes.

8. A method of printing a document comprising the steps of:
generating a format template file by defining locations and sizes on a page of at least two copy holes into which a content element is to be inserted:
creating a group object which incorporates the two copy holes by: generating a hierarchical data structure which specifies an identifier for the group object and identifies each copy hole of which the group object is comprised;
replicating the group object on a page of the format template file; and
creating a merged file by merging the format template file, a style template file specifying a font for a text content element; and each content element identified in respect of a copy hole;
rendering the merged file to create a bitmap; and
operating a print engine in accordance with the bitmap to print a document.

9. A graphic authoring tool adapted to generate a format template file for using in printing, the tool being adapted to:
define a page;
create at least two copy holes on the page into which a content element is to be inserted by specifying for each copy hole:
a location on the page for the copy hole
a size of the copy hole;
an identifier of a location from which a content element may be retrieved for insertion into the copy hole; and
create a group object which incorporates the two copy holes by: generating a hierarchical data structure which specifies an identifier for the group object and identifies each copy hole of which the group object is comprised; and
replicate the group object at one or more further locations on the page or further pages.

10. The authoring tool according to claim 9 further adapted, when creating the group object, to capture relative sizes and positions of the copy holes which comprise the group.
